(19) United States
(12) Patent Application Publication
(10) Pub. No.: US 2017/0310415 A1
(43) Pub. Date: Oct. 26, 2017

(54) D2D OPERATION APPROACHES IN CELLULAR NETWORKS

(71) Applicant: Telefonaktiebolaget LM Ericsson, Stockholm (SE)

(72) Inventors: Santhan THANGARASA, VÄLLINGBY (SE); Muhammad KAZMI, SUNDBYBERG (SE)

(21) Appl. No.: 15/523,417

(22) PCT Filed: Nov. 10, 2015
(86) PCT No.: PCT/SE2015/051190

§ 371 Date: May 1, 2017

Related U.S. Application Data
(60) Provisional application No. 62/077,468, filed on Nov. 10, 2014.

(51) Int. Cl. H04J 11/00; H04W 72/04; H04W 72/12; H04W 88/06

(52) U.S. Cl. CPC H04J 11/0069; H04W 72/1273; H04W 72/042; H04W 88/06

(57) ABSTRACT

There is disclosed a method for operating a network node in a wireless communication network. The method comprises configuring a D2D device for D2D operation based on a D2D schedule or resource allocation such that D2D operation, and/or switching between cellular operation and D2D operation and/or vice versa, of the D2D device doesn't overlap with cellular synchronization signals, and/or with DL subframes that can be used for cell search by the D2D device, and/or with DL subframes in which synchronization signals are transmitted.

The present disclosure also pertains to related devices and methods.

The present disclosure pertains to wireless communication technology, in particular D2D communication.

### BACKGROUND

D2D devices are usually capable of both cellular communication and D2D operation, sometimes simultaneously, sometimes interchangeably. There are important functions of cellular communications which may be interfered by D2D operation, for example functions related to cell search.

### SUMMARY

It is an object of the present disclosure to described approaches limiting the impact of D2D operation on cellular functions, in particular pertaining to cell search procedures or related signaling.

There is presented a method for operating a network node in a wireless communication network. The method comprises configuring a D2D device for D2D operation based on a D2D schedule or resource allocation such that D2D operation, and/or switching between cellular operation and D2D operation and/or vice versa, of the D2D device doesn't overlap with cellular synchronization signals, and/or with DL subframes that can be used for cell search by the D2D device, and/or with DL subframes in which synchronization signals are transmitted.

Moreover, there is considered a network node adapted for configuring a D2D device for D2D operation based on a D2D schedule or resource allocation such that D2D operation, and/or switching between cellular operation and D2D operation, and/or vice versa of the D2D device doesn't overlap with cellular synchronization signals, and/or with DL subframes that can be used for cell search by the D2D device, and/or with DL subframes in which synchronization signals are transmitted.

A method for operating a D2D device in a wireless communication network is also described. The method comprises configuring a D2D operation to take place in subframes outside of a cell search sampling window, and/or to avoid overlap of D2D operation and/or switching between D2D operation and cellular operation and/or vice versa, with at least one time unit or resource for which the network or network node schedules synchronization signals to be transmitted.

Furthermore, a D2D device is considered. The D2D device is adapted for configuring a D2D operation to take place in subframes outside of a cell search sampling window, and/or to avoid overlap of D2D operation and/or switching between D2D operation and cellular operation and vice versa, with at least one time unit or resource for which the network or network node schedules synchronization signals to be transmitted.

Also disclosed is a program product comprising code executable by control circuitry, the code causing the control circuitry to perform and/or control any one of the methods described herein.

In addition, a carrier medium is described. The carrier medium carries and/or stores a program product as described herein and/or code executable by control circuitry, the code causing the control circuitry to perform and/or control any one of the methods described herein.

According to these approaches, D2D operation may be avoided during times or resources intended for cell search or related signaling.

### BRIEF DESCRIPTION OF THE DRAWINGS

The drawings are provided for illustrative purposes, and are not intended to limit the approaches to the embodiments shown.

FIGS. 1a and 1b show an asynchronous and a synchronous example for D2D operation;

FIG. 2 shows an illustration of D2D operation taking place during the neighbour cell search procedure;

FIG. 3 shows a “Direct mode” data path in the EPS (Evolved Packet System) for communication between two UEs;

FIG. 4 shows a “Locally-routed” data path in the EPS for communication between two UEs when UEs are served by the same eNBs;

FIG. 5 shows a default data path scenario in the EPS for cellular communication between two UEs;

FIG. 6 shows an exemplary D2D architecture;

FIG. 7 shows a structure of a UE as example for a D2D device;

FIG. 8 shows an exemplary structure of a base station or network node;

FIG. 9 shows an exemplary flowchart of a method for operating a D2D device;

FIG. 10 shows an exemplary D2D device;

FIG. 11 shows an exemplary flowchart of a method for operating a network node;

FIG. 12 shows an exemplary network node.

### DETAILED DESCRIPTION

A general overview of cell search is provided in the following, often referring to LTE by way of example. In e.g. systems based on LTE/E-UTRAN, the DL subframe #0 and subframe #5 carry synchronization signals (e.g., PSS and/or SSS); in other standards, synchronization signals may be provided in other subframes (or other scheduled time units). In order to identify an unknown cell (e.g. new neighbor cell), the D2D device or UE has to acquire the timing of that cell (e.g. by receiving and/or using a synchronization signal, e.g. PSS and/or SSS and/or a TA value or a broadcast signal, in particular if the new cell is not part of the CA) and eventually the physical cell ID (PCI). Subsequently, the UE may measure RSRP and/or RSRQ of the newly identified cell in order to use the measurement or corresponding measurement values itself and/or to report the measurement and/or measurement values to the network node. In total (in LTE), there are 504 PCIs.

A UE may search or identify a cell (in particular, acquire PCI and/or timing of the cell) by correlating the received synchronization signals, e.g. PSS/SSS signals in DL subframe #0 and/or in DL subframe #5, with one or more of pre-defined PSS/SSS sequences (the pre-defined sequences may be stored in a memory of the UE and/or accessible to control circuitry of the UE). The use of subframe #0 and/or in DL subframe #5 for PCI acquisition depends upon the implementation, in particular on the standard used for cellular communication.

The UE may regularly attempt, and/or be adapted to and/or comprise a cell identification module to regularly attempt, to identify neighbor cells on at least the serving carrier frequenc(ies); such frequencies may be stored in a memory of the UE and/or accessible to control circuitry of the UE and/or provided to the UE e.g. by the network.

Regularly attempting may refer to performing an attempt and/or search and/or identify-procedure at regular intervals and/or periodically, e.g. according to a pre-defined period and/or interval; such a period and/or interval may be configurable, e.g. by the network or a network node.

It may be considered that the UE searches and/or identifies, and/or is adapted to and/or the cell identification module is adapted to, search and/or identify cells on non-serving carrier(s) when configured by the network node, e.g. a radio network node or base station or eNodeB. In order to save UE power consumption, the UE may search and/or identify, and/or the UE and/or the cell identification module may be adapted to search and/or identify, in (either) one of the DL subframes #0 and #5, and/or generally in a subset of time units and/or RBs in which the network or network node provides synchronization signals, the subset being smaller than the set of synchronization signals provided (e.g., the set/subset within pre-determined time interval, e.g. a frame).

In order to further save its battery power, the UE and/or the cell identification module may be adapted to search and/or identify and/or search and/or identify a cell once every 40 ms in non-DRX or in short DRX cycle (e.g. up to 40 ms). In longer DRX cycle the UE typically searches a cell once every DRX cycle. During each search attempt the UE typically stores a snapshot of 5-6 ms and post process by correlating the stored signals with the known PSS/SSS sequences. In non-DRX the UE is able to identify an intra-frequency cell (including RSRS/RSRQ measurements) within 800 ms (i.e. 20 attempts in total including 15 and 5 samples for cell identification (PCI acquisition) and RSRP/RSRQ measurement).

D2D Operation is generally described in the following. D2D devices or UEs may generally be adapted to and/or transmit D2D signals or channels in the uplink part of the spectrum (e.g., as seen from a cellular operation point of view). D2D operation by a UE may be in a half-duplex mode, i.e. the UE can either transmit D2D signals/channels or receive D2D signals/channels. There may also be D2D device or UEs (e.g. a D2D relay device) adapted to relay some signals to other D2D devices or UEs; such devices may generally provide this functionality in addition to their own D2D operational functionality.

Control information or data, e.g. configuration and/or allocation data, for D2D may e.g. transmitted by D2D devices or UEs and/or transmitted by at least one network node, e.g. one or more eNodeBs (e.g., D2D resource grants for D2D communication, which may be transmitted via cellular DL control channels from a network or network node). The D2D transmissions may occur on resources which are configured by the network or selected autonomously by the D2D device or UE (which may generally be referred to as D2D UE).

D2D communication or operation may imply transmitting, by a D2D transmitter or transmitter circuitry of a D2D device (which may also be used or usable or configurable for cellular communication, in particular in UL), D2D data and/or D2D communication control information (e.g. configuration and/or allocation data), e.g. with scheduling assignments (SAs), which may assist D2D receivers (e.g. a receiving D2D device or UE) of the D2D data.

D2D data transmissions may be according to configured patterns, which may be configured by the network and/or network node and/or another D2D device and/or may be pre-configured, e.g. stored in a memory of the D2D device and/or accessible to control circuitry of the D2D device. Such transmission may in principle be transmitted rather frequently. SAs may be transmitted periodically. D2D transmitters (e.g. D2D devices) that are within the network coverage (e.e. covered for cellular communication and/or operation and/or covered by and/or connected or connectable to a cell) may request network or eNodeB resources for their D2D communication transmissions. In response, they may receive D2D resource grants for SA and D2D data or D2D transmissions. Furthermore, eNodeB may broadcast D2D resource pools for D2D communication.

D2D discovery messages may be transmitted in periodic subframes, which may be infrequent in particular in comparison to periodic cellular transmissions. The network, e.g. a or via a network node like an eNodeB, may broadcast D2D resource pools (e.g. in form of (broadcast) configuration or allocation data) for D2D discovery, both for reception and transmission.

D2D communication or operation (and/or a D2D device and/or network node) may support two different modes of D2D operation: mode 1 and mode 2.

In mode 1, the location of the resources for transmission of the scheduling assignment by the broadcasting D2D device or UE comes from the network, e.g. a network node or eNodeB. The location of the resource(s) for transmission of the D2D data by the broadcasting UE comes from the network, e.g. a network node or eNodeB.

In mode 2, a resource pool for scheduling assignment is pre-configured and/or semi-statically allocated. The UE on its own selects the resource for scheduling assignment from the resource pool for scheduling assignment to transmit its scheduling assignment.

Generally, a D2D device or UE and/or a network node may be adapted to support, and/or comprise a D2D module for supporting, D2D operation or communication according to mode 1 and/or mode 2.

PCell interruption of 1 subframe may occur when a D2D device or UE switches its reception between D2D-to-WAN (Wide Area Network, which may be used for cellular operation or cellular network) or WAN-to-D2D.

This is due to the UE receiver chain being retuned every time the operation is switched from WAN to D2D reception and from D2D to WAN reception. This applies to both D2D discovery and D2D communication capable UEs. Uplink resources may be partitioned between cellular uplink and D2D operation in such a way that avoids or minimize the risk of switching taking place in certain subframe, subframe #0 and/or #5, of PCell; a network node may partition (as part of configuring and/or scheduling) and/or be adapted for partitioning accordingly; a network node may comprise a corresponding configuring module (which may be a scheduling module and/or partitioning module and/or be a corresponding sub-module).

These subframes contain essential information such as PSS/SSS that are necessary for doing cell search, carrying out cell measurements and they also contain MIB/SIB1 information which is necessary for SI reading procedures. In addition to interruption that takes places due to switching, there may be additional interruption of 1 subframe due to the RRC reconfiguration procedure. While the switching interruption takes place for single rx UE (e.g. D2D discovery capable UEs), the RRC reconfiguration interruption takes place for all types of D2D UEs (e.g. D2D Discovery capable and D2D Communication capable).

D2D operation is a generic term which may comprise of transmission and/or reception of any type of D2D signals (e.g. physical signals, physical channel etc) by a D2D communication capable UE and/or by D2D discover capable UE. D2D operation is therefore also called as D2D transmission, D2D reception, D2D communication etc. It may be considered that a D2D device is capable of D2D operation, in particular D2D discovery and/or communication.

D2D UE is also interchangeably called as ProSe capable UE. D2D discovery capable UE is also referred to as UE capable of Prose direct discovery and D2D direct communication UE is also referred to as UE capable ProSe direct communication. The link and/carrier that is used for the ProSe direct communication and ProSe direct discovery between UEs may be referred to as sidelink.

A D2D Discovery capable UE, or more generally, a D2D device or UE, with single rx may not be able to receive in both cellular carrier (e.g. DL carrier in FDD) and D2D carrier (e.g. UL carrier in FDD) simultaneously. At least the D2D Discovery capable UE may not mandated to receive signals on both a cellular carrier and a D2D carrier simultaneously. This case may be called a serial configuration of D2D and cellular operation.

The switching of operation between cellular operation to D2D operation (and vice versa) may result in interruption for or of a certain time interval, e.g. of one subframe. There can also be other interruption due to D2D operation as explained herein. When the cells are asynchronous, the timing difference between the radio frames of the cells in the network can be larger than the cyclic prefix, i.e. transmit timing of cells may not be aligned.

A D2D capable UE or D2D device or UE in an asynchronous network performing cell search could experience problems when there is a D2D interruption during the measurement period when UE searches cells. In this case, the synchronization signal, e.g. PSS/SSS information, of neighboring cell/s might be lost if they fall in the interrupted intervals or subframes. Consequently, those cells may not be detected even if their signals are strong enough for detection. This will severely degrade the mobility performance since UE cannot be guaranteed to be served by the strongest cell in terms of signal quality.

The UE may also not be aware of the synchronization level of cells in the network node. Therefore UE may not be able to make any assumption whether a certain neighbor cell being identified or to be identified is synchronous or asynchronous with respect to the transmit timing of a reference cell (e.g. serving cell).

Generally, a network node may be considered to be serving a D2D device or UE if it is able to provide and/or provides a cell for cellular communication to the D2D device or UE and/or is connected to the D2D device or UE via at least one cell, which may be a cell provided by the network node, and/or is connected or connectable in a RRC_connected state and/or if it is adapted to transmit data, e.g. configuration data and/or allocation data and/or payload data, to the D2D device or UE, e.g. via a carrier and/or cellular transmission and/or D2D transmission, and/or to receive data from the D2D device or UE, e.g. via a carrier and/or cellular and/or D2D transmission. A controlling node may be considered to be a network node serving a D2D device or UE.

There are described a method that can be implemented in a network node (e.g. serving eNB) or a D2D device or UE and/or a network node and a D2D device or UE adapted to perform or carry out the actions or steps of the method. A D2D device or UE may be considered to be configured in a cell if it is connected and/or in communication with and/or via the cell and/or it acquired cell ID (e.g. PCI) and/or synchronization or timing and/or successfully performed a random access procedure.

Generally, overlap between D2D operation or switching between operation mode (cellular and D2D or vice versa) and synchronization signals may refer to overlap in regards to time; D2D operation or switching may be considered to overlap with synchronization signals if they coincide in time and/or in a time resource, e.g. a subframe. A reference cell or carrier may be any cell or carrier in regards to which a synchronization state of another or secondary cell or carrier may be determined, e.g. a PCell or its carrier of the D2D device. A secondary cell or carrier may be a cell or carrier having resources and/or a carrier also used for D2D operation, e.g. by the D2D device, which may also perform cellular operation on a PCell. The secondary cell or carrier may be synchronized and/or unsynchronized.

There is disclosed a method for operating a network node (e.g. eNodeB), wherein the network node may be serving a D2D capable UE or D2D device or UE, comprising any one or any combination of the following steps or action. There is also disclosed a network node, which may be adapted for serving a D2D device or UE, the network node being further adapted for any one or any combination of the following:
(optional) Obtaining a first set of information about whether a D2D feature is enabled, e.g. if a D2D device or UE or at least one D2D device or UE is configured in a cell served by the network node; the network node may comprise a first information obtaining module for performing this obtaining;
(optional) Obtaining a second set of information about D2D traffic activity and/or level of D2D traffic activity of the at least one D2D device or UE in the cell and/or about the synchronization state of at least a reference cell and a secondary cell and/or about the scheduling of synchronization signals of at least one cell; wherein the at least one cell may comprise a cell served by the network node and/or at least one cell provided by another network node (to which the D2D device may not be connected and/or which the D2D device may not have identified); the network node may comprise a second information obtaining mode for performing this obtaining;
Adapting D2D resources, e.g. a D2D scheduling resource pattern, (e.g. subframes), which are used or assigned for D2D operation, which adaptation may be based on information obtained in the first- and/or the second sets, and which adapted D2D resources don't overlap in time with DL subframes that can be used for cell search by the at least one D2D device or UE. Alternatively or additionally, there may be considered configuring a D2D device for D2D operation (e.g. transmitting and/or receiving and/or measurements) based on a D2D schedule (or resource allocation) such that D2D operation (and/or switching between cellular operation and D2D operation and/or vice versa) of the D2D device or UE doesn't overlap with cellular synchronization signals provided by the network or network node and/or with DL subframes that can be used for cell search by the at least one D2D device or UE and/or with DL subframes in which synchronization signals (e.g. PSS and/or SSS) are transmitted by the network node, e.g. in DL, for example subframe #0 and/or #5. The configuring may be based on first set of information and/or a second set of information, which may be obtained by either one or both of the obtaining steps or action disclosed above. The network node may comprise an adapting and/or configuring module for performing this adapting and/or configuring. D2D operation may in particular refer to D2D transmission and/or reception.

There is also disclosed a method for operating a D2D device or UE, which may be served by a network node, wherein the method may comprise any one or any combination of the following steps or actions. There is also disclosed a D2D device or UE, which may be adapted to be served by a network or network node, the D2D device or UE further being adapted for any one or any combination of the following:
(optional) Obtaining information that a D2D operation is being performed or is expected to be performed by the D2D device or UE. The D2D device or UE may comprise an information obtaining module for performing this obtaining.
(optional) Adapting a cell measurement procedure during a time period (T1) when the D2D device or UE may perform the D2D operation, which adaptation comprises one or more of:
Avoiding D2D operation during the D2D device or UE cell search sampling time window and/or
Increasing the sampling rate at which the D2D device or UE obtains samples for cell search during T1; the D2D device or UE may comprise a cell measurement adapting module for performing this adapting;
Adapting and/or configuring a D2D operation or operation pattern (resource pattern), in particular D2D operation or operation pattern of the D2D device or UE, so that the D2D operation takes place in subframes outside of the cell search sampling window and/or to avoid overlap between D2D operation and/or switching between D2D operation and cellular operation (and vice versa) in at least one time unit or resource, e.g. a subframe, for which the network or network node schedules synchronization signals to be transmitted, in particular in DL, wherein the synchronization signals may e.g. be PSS or SSS signals, which may be scheduled for transmission and/or transmitted in subframe #0 and/or #5; the adapting and/or configuring may be performed based on configuration and/or allocation data received from the network node and/or base on information obtained by the step or action of obtaining information. The D2D device or UE may comprise an adapting and/or configuring module for performing this adapting and/or configuring.
(Optionally) adapting cell measurement procedure and/or adapting D2D operation pattern may be performed based on explicit permission and/or instruction and/or configuration, e.g. via configuration or allocation data, received from the network node. The D2D device or UE and/or cell adapting module and/or adapting and/or configuration module may be adapted accordingly.

The network may generally schedule and/or transmit synchronization signals on one or more than one cells, which may be provided from different network nodes of the network, one of which may be a controlling node for the D2D device.

This approach enables or facilitates finding of neighboring cells in an asynchronous network by D2D devices or UEs. Moreover, this approach may enable or facilitate features such as mobility, ANR, SON and SI reading that depend on correct detection of neighboring cells to work properly.

Also, this approach may enable or facilitate the UE to continue doing the cell search procedure and also adapt D2D operation. In this way, both cell search and D2D operations are performed without significantly affecting the D2D operation especially in asynchronous network i.e. where cells are unsynchronized.

Multi-Carrier or Carrier Aggregation Operation is described in the following. In multicarrier or carrier aggregation (CA) operation the user equipment (UE; generally, a UE may be seen as and/or be implemented as D2D device in the context of this description; generally, a UE may be adapted for cellular and D2D communication and/or operation, either in parallel and/or simultaneous, or serially, e.g. it may perform only one kind of these operations at a time and may switch between them) is able to receive from and/or transmit data to more than one serving cells. In other words, a CA capable UE can be configured to operate with more than one serving cells. The carrier of each serving cell is generally called as component carrier (CC). In simple words, component carrier (CC) refers to an individual carrier in a multi-carrier system.

The term carrier aggregation (CA) is also called (e.g. interchangeably called) “multi-carrier system”, “multi-cell operation”, “multi-carrier operation”, “multi-carrier” transmission and/or reception. This means CA may be used for transmission of signaling and data in the uplink and downlink directions. One of the CCs is called the primary component carrier (PCC) or simply primary carrier or even anchor carrier. The remaining ones are called secondary component carrier (SCC) or simply secondary carriers or even supplementary carriers. The serving cell associated to the primary component carrier is interchangeably called primary cell (PCell) or primary serving cell (PSC). Similarly the secondary serving cell is interchangeably called as secondary cell (SCell) or secondary serving cell (SSC). Generally, the primary or anchor CC carries the essential UE specific signaling. The primary CC (aka PCC or PCell) may in particular exists in both uplink and downlink directions in CA. In case there is single UL CC, the PCell is arranged on and/or includes that CC. The network may assign different primary carriers (UL and/or DL) to different UEs operating in the same sector or cell.

UE measurements are described in the following. Radio measurements done by the UE are typically performed on the serving as well as on neighbor cells over some known reference symbols or pilot sequences. The measurements are done on cells on an intra-frequency carrier, inter-frequency carrier(s) as well as on inter-RAT carriers(s) (depending upon the UE capability whether it supports that RAT). To enable inter-frequency and inter-RAT measurements for the UE requiring gaps, the network may be adapted to configure the measurement gaps, e.g. by providing a D2D device or UE with corresponding configuration or allocation data.

The measurements may be done for various purposes. Some example measurement purposes are: mobility, positioning, self-organizing network (SON), minimization of drive tests (MDT), operation and maintenance (O&M), network planning and optimization etc. Examples of measurements in LTE are Cell identification aka PCI acquisition, Reference symbol received power (RSRP), Reference symbol received quality (RSRQ), CGI acquisition, Reference signal time difference (RSTD), UE RX-TX time difference measurement, Radio link monitoring (RLM), which consists of Out of synchronization (out of sync) detection and In synchronization (in-sync) detection etc. CSI measurements performed by the UE are used for scheduling, link adaptation etc. by network. Examples of CSI measurements or CSI reports are CQI, PMI, RI etc. They may be performed on reference signals like CRS, CSI-RS or DMRS.

Radio network node radio measurements are described in the following. In order to support different functions such as mobility (e.g. cell selection, handover etc), positioning a UE, link adaption, scheduling, load balancing, admission control, interference management, interference mitigation etc, a (radio) network node, in particular a controlling node, may perform, and/or be adapted to and/or comprise a measurement module to perform, radio measurements on signals transmitted and/or received by the (radio) network node; such signals may be originating from and/or be transmitted by or from one or more associated UEs. Examples of such measurements are SNR, SINR, received interference power (RIP), BLER, propagation delay between UE and itself, transmit carrier power, transmit power of specific signals (e.g. Tx power of reference signals), positioning measurements like TA, eNode B Rx-Tx time difference etc.

In some examples a more general term “network node” is used and it can correspond to any type of radio network node or any network node, which communicates with a UE and/or with another network node. Examples of network nodes are NodeB, MeNB, SeNB, a network node belonging to MCG or SCG, base station (BS), multi-standard radio (MSR) radio node such as MSR BS, eNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. MSC, MME etc), O&M, OSS, SON, positioning node (e.g. E-SMLC), MDT etc.

In some examples the non-limiting term D2D device or user equipment (UE) is used and it refers to any type of wireless device communicating with and/or adapted for communication with or via a network node and/or with another UE in a cellular or mobile communication system. Examples of D2D devices or UEs are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles etc. Any UE may be adapted to be a D2D device, e.g. capable of D2D operation, e.g. D2D transmission, reception and/or discovery.

The approaches herein are applicable to single carrier as well as to multicarrier or to carrier aggregation, e.g. of UE, as described above. They are particularly suitable for D2D device using a receiver circuitry for both D2D operation and cellular operation by switching between operation modes. It may be considered that the D2D device is adapted to share receiver circuitry and/or a receiver between D2D operation and cellular operation, e.g. by switching between those modes of operation.

The examples are described for LTE. However the examples are applicable to any RAT or multi-RAT systems, where the UE receives and/or transmit signals (e.g. data) e.g. LTE FDD/TDD, WCDMA/HSPA, GSM/GERAN, Wi Fi, WLAN, CDMA2000 etc.

A general description of scenarios is presented in the following.

A scenario comprises of at least one network node serving a first cell, say PCell, and another cell that is configurable upon need basis, say SCell1. In some example the SCell1 may be served by a second network node. The examples apply regardless of whether PCell and one or more SCells are served by the same or different network nodes. The network node may also configure a third cell, SCell2 on a different carrier on need basis. The examples presented in this IvD apply for UE configured with CA with any number of SCells.

In some examples, the UE may be configured with PCell and PSCell or with PCell, PSCell and one or more SCells such as in dual connectivity. The configured cells are UE specific and the examples may be applied on UE basis on each configured cell.

There typically may be two types of UEs in the network; the first type, type 1, being the cellular capable UE operating in cellular operation producing cellular traffic, which may be called aka WAN capable UE or legacy UE. The second type, type 2, of UE is the D2D device or UE, which are capable of cellular operation and D2D operation.

A device of type 2 can be configured to operate for only WAN traffic (also referred to cellular traffic) in case D2D operation is not required. The UEs can be configured to operate on any cells. The examples apply when at least one type 2 UE is available in the network, which may be adapted as a D2D device or UE described above, and/or to perform a method for operating a D2D device or UE disclosed herein. Such a UE can be configured with at least one SCell. The PCell, PSCell and SCell(s) are UE specific. However, a plurality of UEs can be configured with the same cell/s as their PCell or SCell or PSCell. Therefore, typically a group of UEs may have the same PCell, which is different than the PCell of another group of UEs.

The examples presented may further be applicable for type 2 UEs (namely D2D devices according to this specification) configured with CA with at least a PCell and with any number of SCells. Typically, the D2D operation may be used on UL radio resources of the SCell (i.e. on UL carrier of SCell in FDD or in UL subframe(s) of the SCell in TDD). The examples may however also be valid if the type 2 UE is configured for D2D operation on one or more DL resources (e.g. carriers, subframes etc) of SCell(s) or even when configured for D2D operation on combination of UL and DL SCells.

The network may serve UEs of both types (or only type 2) and may be an asynchronous network which means that the transmit timing difference between the radio frames of the cells with respect to each other can be arbitrary. For example, in an asynchronous deployment, some cells may have a very large difference in their frame timings with respect to each other (e.g. 2.3 ms), while other others may have a smaller difference in their frame timings with respect to each other (e.g. 2 μs).

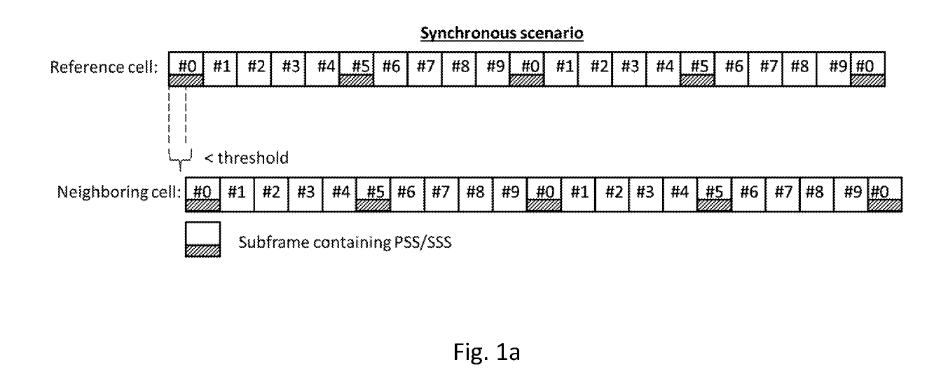

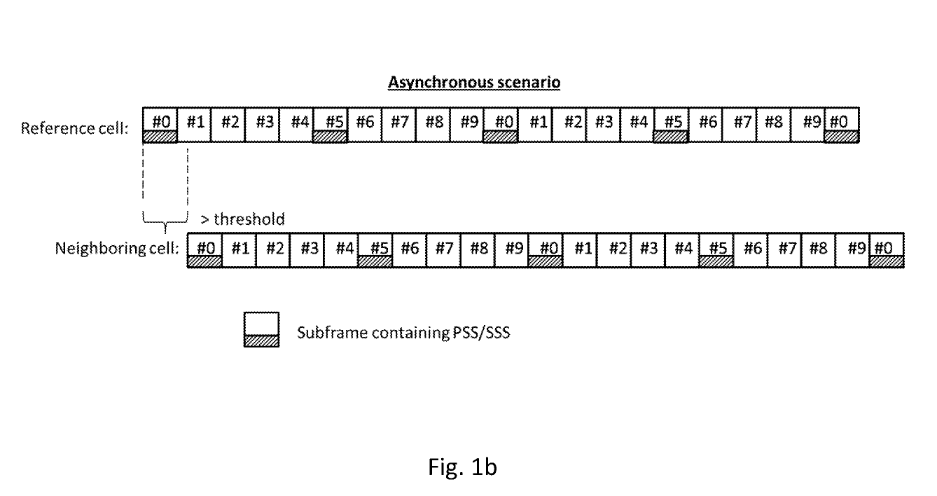

Therefore, the transmit difference between the frames of the cells cannot be guaranteed to be aligned within a certain value or threshold, e.g. CP (Cyclic Prefix) length, 3 μs etc. This is illustrated in FIG. 1. This figure shows that in an asynchronous network deployment (also referred to as unsynchronized network) the difference in transmit timing of the frames of neighbor cells differ with respect to the reference cell of the UE. The difference is generally larger than the certain threshold e.g. cyclic prefix, but is typically around 3 μs. On the other hand, if the difference in transmit timing of the frames of neighbor cells is below or not larger than a pre-defined threshold (e.g. 3 μs) then the cells are considered to be synchronous.

A method in a network node of adapting D2D scheduling and/or configuring D2D operation e.g. based on at least D2D activity and D2D UEs is described in the following.

In this example, there may be one or plurality of type 2 (D2D capable) UEs or D2D devices managed by the network node, which may be a network node as described above and/or adapted for performing a method for operating a network node as described above. The cells in the network in this example may be asynchronous (or unsynchronized); the network may interchangeably be called an asynchronous network. The network node (e.g. eNodeB) of the neighboring cells transmits the PSS/SSS in subframes #0 and #5. These subframes will overlap with other subframes that are not subframe #0 or #5 of the neighboring cells as shown in FIG. 1.

This example is applicable for D2D device or UEs with D2D operation or a corresponding feature enabled in a cell served by a network node. In this case, the network node (respectively its scheduler) may use this information to decide when the D2D operation shall be scheduled. The network node may further use information on D2D traffic level in the operated cell to adapt or change the scheduling of the D2D operation.

In a first example, the network node obtains, e.g. receives, information that a D2D device or UEs exist in the cell that is served the network node. How this information may be received or obtained is described below. The D2D UE can for instance signal its capability to the network node or the network node can be informed by signaling from other nodes e.g. neighboring network node, core network node etc.

The network node may further determine (e.g. based on stored information and/or indication received from another network node) that or whether cells on a particular carrier are synchronized or unsynchronized. In one exemplary example, the network node may adapt D2D scheduling only if the cells on a particular carrier are unsynchronized. In yet another exemplary example the network node may also adapt D2D scheduling if a synchronization level of the cells on a carrier is not known or not known for all the cells.

Upon receiving the information related to at least the presence of D2D UEs in a cell served by the network node, the network node may have two options as follows:
The network node may choose to adapt and/or be adapted to adapt the scheduling towards the said UE and/or to configure the UE to avoid scheduling of D2D operation in certain subframes. More specifically, the network node may choose or be adapted to avoid scheduling of D2D operation in the subframes that are or can be used for cell search i.e. for searching cells on a carrier. Information on which these subframes are may be obtained e.g. from signaling by the UE itself, or obtained from any other nodes in the network. The adaptation of subframes for D2D operation (and/or configuring of the D2D device or UE) may be done by the network node in semi-static or dynamic manner. For example in semi-static adaptation, the network node may allocate a pattern of subframes for D2D during which the UE is not expected to receive DL subframes used for neighboring cell search. The pattern of D2D subframes can be applicable for certain time period e.g. L number of frames, over T0 seconds etc. The assigned subframes for D2D operation don't overlap with DL subframes #0 and/or #5 in cells which the UE will search. In dynamic adaptation, the network node may decide not to schedule (e.g. on a frame basis) certain subframes for D2D operation in case they will overlap with DL subframes used for neighboring cell search i.e. during which the UE is expected to receive DL subframes #0 and/or #5 of neighbor cells for cell search.
The network node may choose and/or be adapted to obtain further information about the level of D2D activity of the said UE. If the D2D traffic/activity level is greater than a threshold, the network node may choose to adapt and/or be adapted to adapt its scheduling and/or to configure the D2D device in such a way that avoids scheduling of D2D operation in subframes that are used for cell search sampling. If the obtained information indicates that the D2D activity level is below a threshold in the said UE, then the network UE may choose to keep its scheduling of D2D subframes unchanged.

The network node may adapt the scheduling of the D2D UE.

Adapting the scheduling of the D2D UE and/or configuring the D2D device by the network node may aim at and/or be performed for avoiding scheduling D2D operation in the subframes that are used by the D2D UE for searching for PSS/SSS of the neighboring cells and/or in which the network node transmits synchronization signals. The reason is avoid D2D interruption taking place during these subframes.

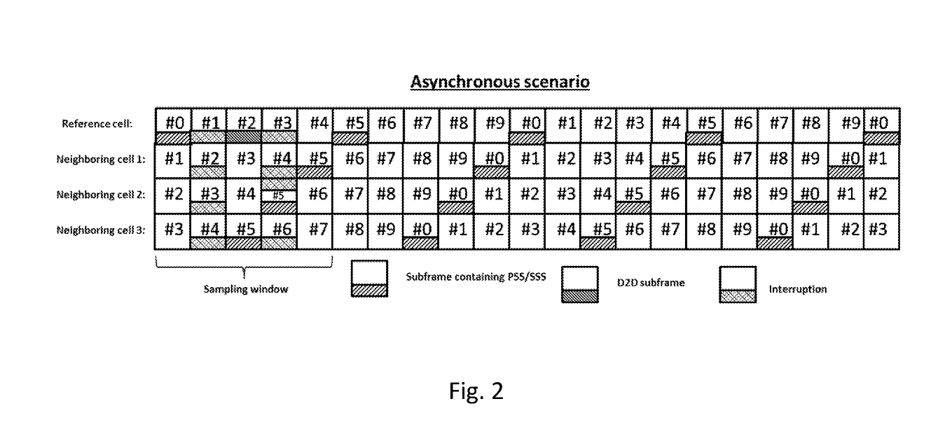

FIG. 2 shows the subframes from an UE point of view. It can be seen that the subframes are not aligned in time. The D2D UE starts the cell search sampling at subframe #0 in reference to its serving/reference cell and the sampling duration in this example figure is 5 ms. It is notable that the typical sampling duration is 5 ms. It is further assumed that the D2D UE is configured for D2D operation on subframe #2 which means that the switching takes place on subframe #1 and subframe #3. The switching will cause an interruption of 1 ms; thus the UE will not be able to measure on these subframes and the PSS/SSS provided in subframe #5 of neighbour cell 2 will be lost.

In addition, PSS/SSS of neighbor cell 3 will also be lost due to that the UE is configured for e.g. D2D reception on that subframe since the D2D capable UE with single rx cannot receive in D2D and cellular downlink carrier simultaneously. Therefore PSS/SSS of neighbor cells 2 and 3 will be lost, i.e. PSS/SSS of these cells will not be detected within the cell search sampling window (aka snapshot) even if the signal quality of these cells is sufficiently good enough. By adapting the scheduling pattern of said D2D UEs, the network node disallows any D2D operation within the cell search sampling duration. This results in no impact on the neighbor cell search procedure due to D2D.

Examples of criteria to determine the traffic activity are buffer size (respectively buffer fill state), average bit rate measured on D2D and/or WAN signals transmitted between UE and the serving cell and/or between D2D UEs, etc. The traffic activity can be determined in UL and/or DL on one or more serving cells. The information about D2D activity may also be determined by the network node by measuring at the network node, the D2D signals transmitted by the D2D UE on the UL carrier frequency. In yet another example the UE may explicitly signal D2D activity information to the network node via communication link between the D2D UE and the network node.

This example also includes method in the network node that based on information such as D2D traffic activity of one or more D2D UEs in the cell, number of D2D UEs in the cell, or any other type of D2D related information sends command to one or more D2D UEs requesting them to adapt their cell search procedure and scheduling.

A method in a UE of adapting a cell search measurement procedure based on D2D activity is described in the following. This example discloses an approach or method in a D2D device or UE (which may be of type 2). The approach or method may enable or adapt or configure the D2D device or UE to adapt the cell search measurement procedure based on D2D activity and/or whether the D2D operation is enabled for the said UE. The adaptation of the cell search measurement procedure comprises adapting one or more parameters used for or involved in identifying a new cell while the UE is configured with D2D operation. As an example the D2D device may configure itself and/or a cell measurement adapting module may adapt one or more of the following parameters:
the cell search sampling window based on D2D activity and/or whether the D2D operation is enabled for the said UE
the cell search sampling rate based on D2D activity and/or whether the D2D operation is enabled for the said UE. The sampling rate defines how often or frequently the UE obtains a sample for cell search e.g. typically UE takes one sample every 40 ms.

The UE, in general, needs to take samples for certain duration in order to detect subframe #0 or #5 since it has no information on where the subframes of the different cells fall in time-domain. This is particularly critical in the asynchronous network where the subframes of the neighbor cells may be shifted in time and may therefore only partly overlap with each other. Since the PSS/SSS are provided in both subframes #0 and #5, the typical sample duration is 5 ms which means that at least one of the subframes #0 or 5 will be captured in the sampling window. The sampling and the sampling duration (in particular within the sampling window) is typically UE implementation specific. The UE after obtaining the sample (e.g. 5 ms or slightly longer such as 5.2 ms), stores the sample and post processes the obtained sample by correlating it with pre-defined PSS/SSS sequences to identify the PCI of the cell. As mentioned herein, the D2D operation may cause interruption in the subframes and due to which the sample obtained by the UE may not contain the subframes containing PSS/SS. This example comprises a method in D2D capable UEs to solve this problem as follows:
A restriction in the cell search sampling window that involves disallowing any D2D operation within the cell search sampling window. This makes sure that no interruption of WAN signals (respectively of reception of such signals) occurs during the search window.
Adapting the D2D scheduling (e.g. D2D transmission and/or operation) in a way that D2D operation falls outside of the cell search sampling window One or more criteria for the UE to apply the options presented above can be as follows:
   D2D activity in the said UE
   D2D activity in the serving cell
   Level of D2D traffic activity in the said UE
   D2D activity function enabled/disabled
   Searching a cell while the UE is configured to perform one or more D2D operations, which may cause interruption on the serving cell of the D2D UE
   Synchronization level of cells on a carrier; if this is known to the UE.

This example also includes the method in which the D2D device (or D2D capable UE) receives a command from the network node to adapt its cell search sampling window and/or D2D scheduling pattern and/or is configured accordingly by the network node. In response to the reception of the command (and/or corresponding configuration data), the D2D capable UE may follow the instruction in the command. The network node may or may not allow the D2D UE to adapt its cell search sampling window and/or D2D scheduling pattern. For example, in some scenarios such as when D2D operation should be performed (e.g. emergency situation etc), the network node may allow the UE not to adapt its cell search sampling window and/or D2D scheduling pattern; rather the UE can be allowed to continue D2D operation even if that would lead to missing of identification of certain cells.

The advantage of this example is that the interruption within the cell search sampling window due to D2D is removed. Consequently, no subframes containing PSS/SSS will be lost due to D2D operation within this duration. This means that the problem of failing to capture PSS/SSS that fall within the D2D interruption subframes is solved. This may lead to features such as mobility management, SON, ANR and positioning relying on identification of new cells to work more properly.

Obtaining information by the D2D Device or UE may generally comprise any one or any combination of:
the D2D device or UE detecting that there is an ongoing D2D activity in the UE. In this case, the D2D device or UE may identify its cell search sampling window starts at subframe n and continues for a duration of X subframes. The UE then may choose and/or be adapted to prohibit any D2D operation during the X subframes starting from subframe n;
the D2D device or UE may choose and/or be adapted to only allow D2D subframes (subframes in which D2D operation is scheduled and/or performed) to take place only in the subframes that fall outside of X. E.g. in 40 ms cell search cycle, where UE searches a new cell once every 40 ms, the D2D operation could take place in subframes which are 40-X.
the D2D device or UE detecting that there is an ongoing D2D activity in the UE. Detecting may include determining whether the D2D activity is very low and that the D2D operation takes places occasionally (e.g. based on D2D historical traffic activity). In this case, the D2D UE may choose and/or be adapted to not make any changes to the sampling window or the scheduling pattern.
The D2D device or UE receiving explicit command and/or configuration data from the network node requesting or configuring the UE to adapt the cell search window and scheduling to facilitate D2D operation. The UE may choose to take action accordingly, e.g. by configuring itself accordingly (e.g., according to the configuration data received);
Adapting the cell measurement procedure (e.g. due to the D2D device or UE configuring itself accordingly) may include any one or any one combination of:
adapting the cell search sampling rate at which D2D device or UE obtains a sample for cell search and/or configuring the D2D device or UE accordingly, e.g. by itself. For example, in some cases the UE may not be able to avoid D2D operation due to which the UE may miss DL subframes #0 and/or #5 containing synchronization signals, e.g. PSS/SSS, from or via one or more than one cells. In this case the UE may also adapt its sampling rate. For example due to D2D operation instead of search a cell every 40 ms, the UE may search more often (e.g. every 20 ms or even 10 ms). It is less likely that D2D operation occurs during all samples. The higher sampling rate will therefore increase the chances of identifying the cell;
adapting the sample size as well as the sampling rate for identifying a cell while configured for D2D operation;
Adapting the sample size and/or the sampling rate for identifying a cell selectively. The said selective adaptation may be based on the D2D device's or UE's knowledge about synchronization level of cells on a carrier (e.g. in reference to a reference cell or carrier) on which the UE searches cell. For example, the D2D device or UE may obtain information about the synchronization level of cells on a carrier based on one or more of: historical data or stored information such as past cell search knowledge, explicit indication received from the network node. If the UE determines that the cells are unsynchronized (e.g. transmit time difference between frame timing of neighbor cells and a reference cell is larger than a threshold (e.g. 3 μs), then the D2D device or UE may adapt one or more parameters used for cell search procedure and avoid D2D operation during the cell search sample. Otherwise the UE may not adapt any parameter used for cell search procedure and may still continue with D2D operation during the cell search sample.

Alternatively or additionally to the above, there may be considered:

A cell identification procedure by D2D device or UEs is discussed in the following. The cell search procedure applies to D2D devices or UEs in RRC_CONNECTED state that try to identify their neighbouring cells provided that their serving cell is already identified and the carrier frequency synchronization is already known at the UE. Finding new neighbouring cells is fundamental to support functionality such as mobility and SI reading. It is only when the new cells have been identified the RRM measurements such as RSRP/RSRQ, which serve as basis for mobility decisions, can be carried out.

Cell identification includes both detecting a cell (i.e. acquisition of Physical Cell ID and/or timing) and also performing a single measurement or at least one measurement (e.g. RSRP or RSRQ) on the detected cell. The existing requirement for PCI acquisition time for intra-frequency cell is 600 ms which means that PSS/SSS have to be detected within this time. In a typical FDD scenario, both PSS/SSS information are provided in subframes #0 and #5 and UEs are always able to perform downlink measurements. However, this may not be the case for D2D UEs because D2D operation is in half-duplex mode from a UE point of view. The downlink may be subject to interruption due to switching of operation. This means that in the case that the D2D interruption occurs when synchronization signals are scheduled and/or transmitted by the network and/or network node, e.g. in both subframe #0 and subframe #5, no synchronization signals, respectively no PSS/SSS, will be available at the UE in that particular radio frame. This will impact the cell search procedure significantly.

In similar scenarios, e.g. HD-FDD with low-cost MTC UEs, a subframe condition may be introduced to make sure that at least downlink subframe #0 or #5 is made available at the D2D device or UE for cell search purpose. If the network can make sure that one of these subframes is available, then the cell search requirements shall be met. WAN (cellular) procedures generally should be prioritized over D2D operation if they take place simultaneously. This means that the WAN uplink is prioritized over D2D uplink or downlink. Even though the WAN downlink is in principle separated from D2D operation, the interruption still affects the downlink.

This can be exemplified using two examples. In the first example, it is assumed that the eNodeBs are synchronized as shown in FIG. 1. This figure shows the timing of two cells from a UE point of view. It is shown that in asynchronous network deployment (or unsynchronized network deployment), the difference in transmit timing of the frames of neighbour cells differ with respect to a reference cell of the UE. The difference is generally larger than a certain threshold, e.g. cyclic prefix duration, but is typically around 3 μs. On the other hand, if the difference in transmit timing of the frames of neighbour cells is below not larger than a threshold (e.g. 3 μs) then the cells are considered to be synchronous. The transmit timing difference in the asynchronous case can also be in the order of several slots or subframes. FIG. 1a shows the synchronous scenario, whereas FIG. 1b shows the asynchronous scenario.

In the synchronous scenario, when the cells are synchronized, the subframes of the neighbouring cells are aligned e.g. within 3 μs. This means that the UE or the serving eNodeB could avoid that interruption takes place on subframes #0 and/or subframe #5. During the cell search procedure the UE typically samples once every 40 ms. The sample duration or sampling window is typically 5 ms (or >5.0 ms) long and either subframe #0 or #5 will always be captured within that sampling window. In the synchronous scenario this would work, because the PSS/SSS of the neighbouring cells would always fall within the sampling window since the subframes are aligned. In the asynchronous scenario where the timing is not aligned, the cell search of neighbouring cells procedure becomes a problem.

As illustrated in the FIG. 2, the subframes of the reference cell and the neighbouring cell may not be aligned. For instance, the subframe #0 of the reference cell will overlap with subframe #1 of the first neighboring cell, and with subframe #2 of the second neighbouring cell etc. Also in this scenario one of the subframes #0 or #5 will be captured if a sampling window greater than 5 ms is used provided there is no D2D operation during the cell search sampling window.

A D2D Discovery capable UE with single Rx antenna may need to switch between WAN reception and D2D reception. The D2D resources are allocated semi-statically by the serving eNodeB. The D2D Discovery operation could take place for a certain number of contiguous subframes, e.g. 64 contiguous subframes as given in one example. This means during 64 contiguous subframes the D2D device or UE should be tuned to receive in the uplink spectrum. Thus the device or UE cannot receive the WAN transmissions simultaneously. Since the resources are semi-statically configured, it may be very difficult for the UE to prioritize the WAN reception e.g. on subframe-basis. One consequence of this would be that the D2D Discovery capable device or UE will not be able to receive the subframes #0 or #5 containing PSS/SSS during 64 subframes. This is a problem because the D2D device or UE typically needs to sample once every 40 ms during the physical measurement period of 200 ms (typical case). This means that 2 out of the 5 possible samples may be impacted. A solution to overcome this problem is to not allow D2D transmission during the PSS/SSS sampling window.

Another concern of cell search procedure for D2D Discovery capable UEs takes place in the asynchronous scenario when D2D operation is allowed during the neighbour cell search procedure. This is illustrated in FIG. 2.

FIG. 2 shows an illustration of D2D operation taking place during the neighbour cell search procedure. In particular, FIG. 2 shows the subframes from an D2D device or UE point of view. It can be seen that the subframes are not aligned. The D2D device or UE starts the sampling at subframe #0 in reference to its reference/serving cell and the sampling duration is 5 ms. In this example, it is assumed that the D2D device or UE is configured for D2D operation on subframe #2 of the reference cell. This means that the switching takes place on subframe #1 and subframe #3. The switching causes interruption; thus the device or UE will not be able to measure on these subframes and the PSS/SSS provided in subframe #5 of neighbour cell 2 will be lost. In addition, PSS/SSS of neighbour cell 3 will also be lost due to that the UE is configured for D2D reception on that subframe. Therefore, PSS/SSS signaling of neighbour cells 2 and 3 will be lost, i.e. PSS/SSS of these cells will not be detected even if the signal quality of these cells is significantly good, due to D2D operation taking place in the subframes of the cell search sampling window.

One approach includes that the D2D UE (also called D2D device or UE herein) does not perform any D2D operation (D2D reception or transmission) during its PSS/SSS sampling window used for cell search. The D2D UE is not aware whether the network is synchronous or asynchronous. Therefore, the D2D UE may avoid D2D operation during its PSS/SSS sampling window regardless of whether the network is synchronous or asynchronous.

Another approach includes that the eNB configures D2D subframes or schedules the D2D UE on subframes that would not overlap with PSS/SSS of neighbour cells to minimize the impact on cell search procedure in asynchronous scenario. In other words it guarantees that the DL subframes #0 and/or #5 are available for cell search also in neighbour cells. This solution may result in no or less impact on the cell search procedure. However this also puts constrain on network scheduling and partitioning or sharing of resources between WAN and D2D. A D2D UE can handle cell search by avoiding D2D operation during a cell search window e.g. according to the approach:
Proposal #1: D2D UE meets existing cell search requirements.
Proposal #2: No condition on availability of DL subframes #0 and/or #5 for cell search is specified.
Observation #1: To fulfil existing cell search requirements (Proposal#1) and considering proposal #2, the D2D UE will have to avoid D2D operation during the cell search sampling window.

It is suggested for the network node to take into account information on D2D UEs in the cells, whether D2D feature is enabled, and/or D2D traffic activity and/or the level of traffic activity, to adapt its cell search sampling procedure and scheduling in such a way that D2D subframes take place outside of the cell search sampling window. The network node may also send explicit command to D2D UEs requesting them to change their cell search- and/or scheduling behavior to avoid or minimize D2D interruptions and facilitate D2D operation.

There is also suggested a method for operating a D2D device or UE taking into account information on D2D traffic activity and/or level of traffic activity and/or whether the D2D feature is enabled to adapt its cell search sampling window and also to adapt the D2D operation scheduling pattern to take place in in the subframes outside of cell search window.

Generally, a UE may be considered as an example or representative of a D2D device, and the term D2D device or D2D UE may be interchanged for UE unless explicitly stated otherwise.

An eNodeB or eNB or base station may be considered to be one variant of a network node, in particular a controlling node.

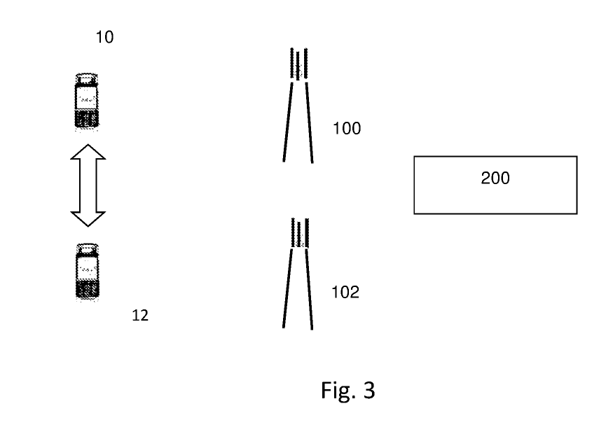

In FIGS. 3 to 5, there are shown different setups for communication of user equipments (as examples for D2D devices) within a wireless or mobile communication network. In these figures, the first node or first user equipment UE1 is indicated with reference numeral 10, the second node or second user equipment is indicated with reference numeral 12. A first base station or network node, which may be an eNodeB and/or EPC according to LTE/E-UTRAN, carries the reference numeral 100, whereas a second base station, which may be an eNodeB and/or EPC according to LTE/UTRAN, is referenced with numeral 102. The nodes 100, 102 may be configured as coordinating nodes for D2D communication between the UEs 10, 12. Reference numeral 200 indicates higher layer functions or devices of the network, to which the base stations 100, 102 may be connected or connectable, e.g. LTE packet core elements like SGW (Server GateWay) and/or PGW (PDN GateWay) and/or MME (Mobility Management Entity).

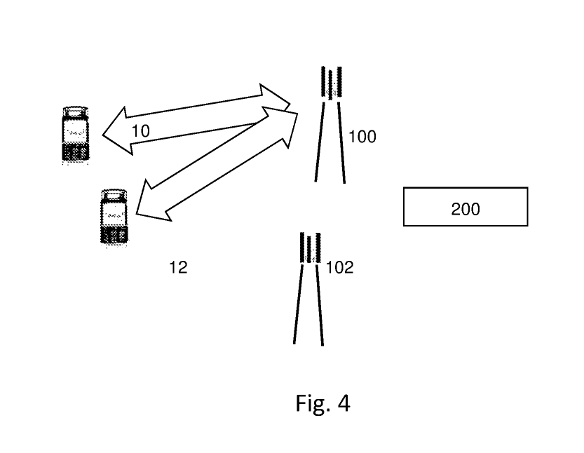

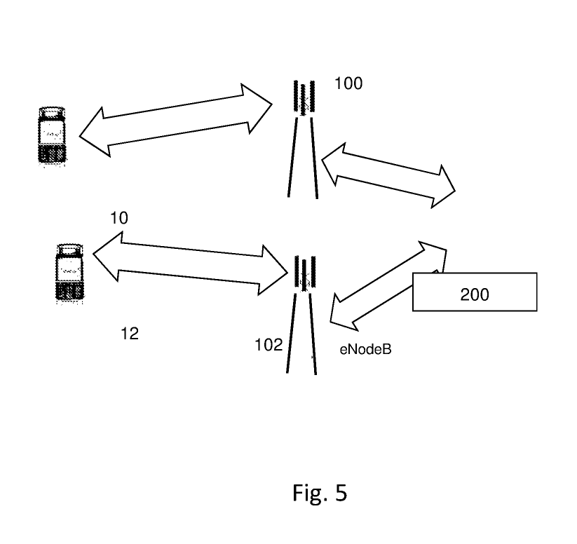

If UEs 100, 102 are in proximity to each other, they may be able to use a “direct mode” (e.g., as in FIG. 3) or “locally-routed” (e.g., as in FIG. 4) path for data communication, unlike in the conventional cellular communication (FIG. 5).

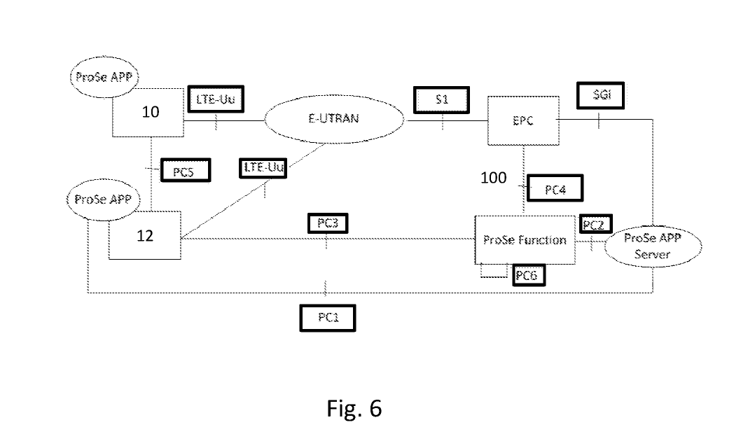

A more detailed example reference architecture for D2D operation according to one possible LTE/E-UTRAN implementation is illustrated in FIG. 6, in which only a setup with two UEs 10, 12 connected to a common base station or eNodeB 100 is shown. In FIG. 4, PCn identifies different reference points or interfaces. PC1 refers to a reference point between a ProSe application ProSe APP running on an D2D device or UE 10 or 12, PC2 a reference point between an ProSe Application server and a ProSe function provider on a server or base station side. PC3 indicates a reference point between the D2D device or UE 12 and the ProSE function, e.g. for discovery and/or communication. PC4 refers to a reference point between the EPC and the ProSe function, e.g. for setting up setting up one-to-one communication between UEs 10 and 12. PC5 is a reference point between D2D device or UE 10 and D2D device or UE 12, e.g. a first node and a second node involved in D2D communication, which may be used e.g. for direct or relayed communication between the UEs. PC6 identifies a reference point between ProSE functions of different networks, e.g. if UEs 10, 12 are subscribed to different PLMNs (Public Land Mobile Networks). SGi indicates an interface which may be used, inter alia, for application data and/or application level control. The EPC (Evolved Packet Core) may generally include a plurality of core packet functions or entities, e.g. MME, SGW, PWG, PCRF (Policy Charging and Rules Function), HSS (Home Subscriber Server), etc. E-UTRAN is the preferred RAT of the arrangement of FIG. 4. LTE-Uu indicates data transmission connections between the UEs 10, 12 and the base station 100.

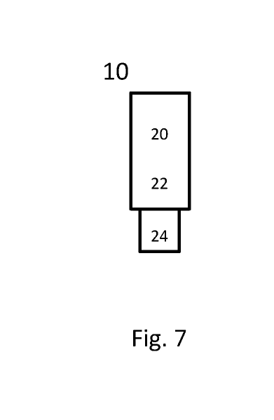

FIG. 7 schematically shows a D2D device or user equipment 10, which may be a node of or for a device-to-device communication, in closer details. User equipment 10 comprises control circuitry 20, which may comprise a controller connected to a memory. A receiving module and/or transmission module and/or control module may be implemented in the control circuitry 20, in particular as module in the controller. The user equipment also comprises radio circuitry 22 providing receiving and transmitting or transceiving functionality, the radio circuitry 22 connected or connectable to the control circuitry. An antenna circuitry 24 of the user equipment 10 is connected or connectable to the radio circuitry 22 to collect or send and/or amplify signals. Radio circuitry 22 and the control circuitry 20 controlling it are configured for device-to-device communication, in particular utilizing E-UTRAN/LTE resources as described herein and/or receiving allocation data and/or transmit D2D data based on allocation or configuration data. Any module of the D2D device or user equipment may be implemented in the circuitries described herein, in particular the control circuitry.

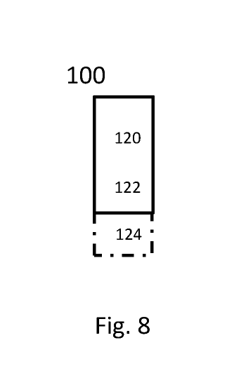

FIG. 8 schematically show a base station 100, which in particular may be an eNodeB. Base station 100 comprises control circuitry 120, which may comprise a controller connected to a memory. A configuring unit and/or a determination unit may be comprised in the control circuitry, the latter in particular if the base station is configured as a coordinating node. The control circuitry is connected to control radio circuitry 122 of the base station 100, which provides receiver and transmitter and/or transceiver functionality. It may be considered that control circuitry 120 comprises an extracting unit as described herein, in particular if the base station is configured to participate as a device in D2D communication. An antenna circuitry 124 may be connected or connectable to radio circuitry 122 to provide good signal reception or transmittance and/or amplification. Any module of the network node or base station may be implemented in the circuitries described herein, in particular the control circuitry.

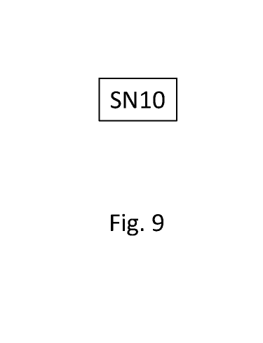

FIG. 9 schematically shows a method for operating a network node, which may be any network node described herein. The method comprising an action SN10 of configuring a D2D device for D2D operation based on a D2D schedule or resource allocation such that D2D operation, and/or switching between cellular operation and D2D operation and/or vice versa, of the D2D device doesn't overlap with cellular synchronization signals, and/or with DL subframes that can be used for cell search by the D2D device, and/or with DL subframes in which synchronization signals are transmitted.

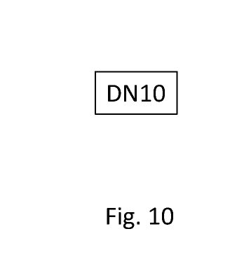

FIG. 10 schematically shows a network node comprising a configuring module DN10 for performing action SN10.

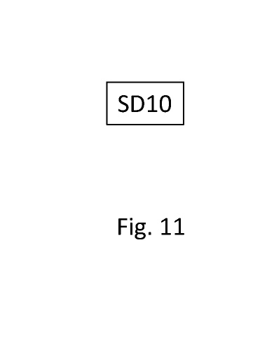

FIG. 11 schematically shows a method for operating a D2D device, which may be any D2D device described herein. The method comprises an action SD10 of configuring a D2D operation to take place in subframes outside of a cell search sampling window, and/or to avoid overlap of D2D operation and/or switching between D2D operation and cellular operation and vice versa, with at least one time unit or resource for which the network or network node schedules synchronization signals to be transmitted.

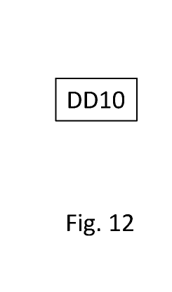

FIG. 12 schematically shows a D2D device comprising a configuring module DD10 for performing action SD10.

There is disclosed a program product comprising code executable by control circuitry, the code causing the control circuitry to perform and/or control at least any one of the methods for operating a D2D device or UE or a network node described herein.

Moreover, there may be considered a carrier medium carrying and/or storing at least any of the program products described herein and/or code executable by control circuitry, the code causing the control circuitry to perform and/or control at least any one of the methods for operating a D2D device or UE or a network node described herein. Generally, a carrier medium may be accessible and/or readable and/or receivable by control circuitry. Storing data and/or a program product and/or code may be seen as part of carrying data and/or a program product and/or code. A carrier medium generally may comprise a guiding/transporting medium and/or a storage medium. A guiding/transporting medium may be adapted to carry and/or carry and/or store signals, in particular electromagnetic signals and/or electrical signals and/or magnetic signals and/or optical signals. A carrier medium, in particular a guiding/transporting medium, may be adapted to guide such signals to carry them. A carrier medium, in particular a guiding/transporting medium, may comprise the electromagnetic field, e.g. radio waves or microwaves, and/or optically transmissive material, e.g. glass fiber, and/or cable. A storage medium may comprise at least one of a memory, which may be volatile or non-volatile, a buffer, a cache, an optical disc, magnetic memory, flash memory, etc.

Generally, there may be considered a D2D device adapted to perform any one of the methods for operating a D2D device described herein.

Additionally or alternatively, there may generally be considered a network node, in particular a controlling node, adapted to perform any one of the methods for operating a network node, like a controlling node, described herein.

A network node may generally be implemented as a controlling node and/or a base station or eNodeB.

A mobile communication network may generally comprise one or more than one network nodes, in particular a controlling node as described herein, and/or a radio access network (which may comprise the one or more than one network nodes) and/or a core network connected or connectable to the radio access network. The network and/or controlling node may be adapted to provide one or more cells for wireless and/or radio communication and/or to serve one or more D2D devices or UEs. A mobile communication network may be a cellular network. The controlling node may be adapted for controlling and/or serving and/or provide and/or support cellular communication and/or D2D communication.

Configuring a D2D device may involve instructing and/or causing the D2D device to change its configuration, e.g. at least one setting and/or register entry and/or operational mode. Configuring a D2D device for D2D measurement may refer to instructing and/or causing the D2D device to change operational parameters for D2D measurement, in particular according to a measurement performance characteristic. A D2D device may be adapted to configure itself. Configuring a D2D device by another device or node or network may refer to transmitting information and/or data and/or instructions to the D2D device by the other device or node or network, e.g. at least one measurement performance characteristic, based on which the D2D device may configure and/or reconfigure, e.g. a D2D configuration, which may involve changing one or more parameters and/or settings.

Adapting a measurement procedure and/or a configuration and/or a D2D device or UE may refer to configuring the D2D device, in particular by changing the configuration, e.g. by the D2D device.

In the context of this description, wireless communication may be communication, in particular transmission and/or reception of data, via electromagnetic waves and/or an air interface, in particular radio waves, e.g. in a wireless communication network and/or utilizing a radio access technology (RAT). The communication may be between nodes of a wireless communication network and/or in a wireless communication network. It may be envisioned that a node in or for communication, and/or in, of or for a wireless communication network is adapted for, and/or for communication utilizing, one or more RATs, in particular LTE/E-UTRA. A communication may generally involve transmitting and/or receiving messages, in particular in the form of packet data. A message or packet may comprise control and/or configuration data and/or payload data and/or represent and/or comprise a batch of physical layer transmissions. Control and/or configuration data may refer to data pertaining to the process of communication and/or nodes of the communication. It may, e.g., include address data referring to a node of the communication and/or data pertaining to the transmission mode and/or spectral configuration and/or frequency and/or coding and/or timing and/or bandwidth as data pertaining to the process of communication or transmission, e.g. in a header. Each node involved in such communication may comprise radio circuitry and/or control circuitry and/or antenna circuitry, which may be arranged to utilize and/or implement one or more than one radio access technologies. Radio circuitry of a node may generally be adapted for the transmission and/or reception of radio waves, and in particular may comprise a corresponding transmitter and/or receiver and/or transceiver, which may be connected or connectable to antenna circuitry and/or control circuitry. Control circuitry of a node may comprise a controller and/or memory arranged to be accessible for the controller for read and/or write access. The controller may be arranged to control the communication and/or the radio circuitry and/or provide additional services. Circuitry of a node, in particular control circuitry, e.g. a controller, may be programmed to provide the functionality described herein. A corresponding program code may be stored in an associated memory and/or storage medium and/or be hardwired and/or provided as firmware and/or software and/or in hardware. A controller may generally comprise a processor and/or microprocessor and/or microcontroller and/or FPGA (Field-Programmable Gate Array) device and/or ASIC (Application Specific Integrated Circuit) device. More specifically, it may be considered that control circuitry comprises and/or may be connected or connectable to memory, which may be adapted to be accessible for reading and/or writing by the controller and/or control circuitry. Radio access technology may generally comprise, e.g., Bluetooth and/or Wifi and/or WIMAX and/or cdma2000 and/or GERAN and/or UTRAN and/or in particular E-Utran and/or LTE.

A communication may in particular comprise a physical layer (PHY) transmission and/or reception, onto which logical channels and/or logical transmission and/or receptions may be imprinted or layered. A node of a wireless communication network may be implemented as a D2D device and/or user equipment and/or base station and/or relay node and/or any device generally adapted for device-to-device communication. A wireless communication network may comprise at least one of a device configured for device-to-device communication, a D2D device, and/or a user equipment and/or base station and/or relay node, in particular at least one user equipment, which may be arranged for device-to-device communication with a second D2D device or node of the wireless communication network, in particular with a second user equipment. A node of or for a wireless communication network may generally be a wireless device configured for wireless device-to-device communication, in particular using the frequency spectrum of a cellular and/or wireless communications network, and/or frequency and/or time resources of such a network. Device-to-device communication may optionally include broadcast and/or multicast communication to a plurality of devices or nodes. A cellular network may comprise a network node, in particular a radio network node, which may be connected or connectable to a core network, e.g. a core network with an evolved network core, e.g. according to LTE. The connection between the network node and the core network/network core may be at least partly based on a cable/landline connection.

Operation and/or communication and/or exchange of signals involving part of the core network, in particular layers above a base station or eNB, and/or via a predefined cell structure provided by a base station or eNB, may be considered to be of cellular nature or be called cellular operation. Operation and/or communication and/or exchange of signals without involvement of layers above a base station and/or without utilizing a predefined cell structure provided by a base station or eNB, may be considered to be D2D communication or operation, in particular, if it utilises the radio resources, in particular carriers and/or frequencies, and/or equipment (e.g. circuitry like radio circuitry and/or antenna circuitry, in particular transmitter and/or receiver and/or transceiver) provided and/or used for cellular operation.

A user equipment (UE) may generally be a device configured for wireless device-to-device communication (it may be a D2D device) and/or a terminal for a wireless and/or cellular network, in particular a mobile terminal, for example a mobile phone, smart phone, tablet, PDA, etc. A user equipment may be a node of or for a wireless communication network as described herein, in particular a D2D device. It may be envisioned that a user equipment or D2D device is adapted for one or more RATs, in particular LTE/E-UTRA. A user equipment or D2D device may generally be proximity services (ProSe) enabled, which may mean it is D2D capable or enabled. It may be considered that a user equipment or D2D device comprises radio circuitry and/control circuitry for wireless communication. Radio circuitry may comprise for example a receiver device and/or transmitter device and/or transceiver device. Control circuitry may include a controller, which may comprise a microprocessor and/or microcontroller and/or FPGA (Field-Programmable Gate Array) device and/or ASIC (Application Specific Integrated Circuit) device. It may be considered that control circuitry comprises or may be connected or connectable to memory, which may be adapted to be accessible for reading and/or writing by the controller and/or control circuitry. A node or device of or for a wireless communication network, in particular a node or device for device-to-device communication, may generally be a user equipment or D2D device. It may be considered that a user equipment is configured to be a user equipment adapted for LTE/E-UTRAN.

A network node may be a base station, in particular a radio base station, and/or an eNodeB (e.g., in the context of LTE/E-UTRA). In particular, a network node or base station may be any kind of base station of a wireless and/or cellular network adapted to serve one or more D2D devices and/or user equipments. It may be considered that a base station is a node of a wireless communication network or network node. A base station may be adapted to provide and/or define one or more cells of the network and/or to allocate or schedule frequency and/or time resources for communication to one or more nodes of a network, in particular UL resources, for example for device-to-device communication, which may be communication between devices different from the base station. Generally, any node adapted to provide such functionality may be considered a base station. It may be considered that a base station or more generally a network node, in particular a radio network node, comprises radio circuitry and/or control circuitry for wireless communication.

It may be envisioned that a base station or network node is adapted for one or more RATs, in particular LTE/E-UTRA. Radio circuitry may comprise for example a receiver device and/or transmitter device and/or transceiver device. Control circuitry may include a controller, which may comprise a microprocessor and/or microcontroller and/or FPGA (Field-Programmable Gate Array) device and/or ASIC (Application Specific Integrated Circuit) device. It may be considered that control circuitry comprises or may be connected or connectable to memory, which may be adapted to be accessible for reading and/or writing by the controller and/or control circuitry. A base station may be arranged to be a node of a wireless communication network, in particular configured for and/or to enable and/or to facilitate and/or to participate in device-to-device communication, e.g. as a device directly involved or as an auxiliary and/or coordinating node. Generally, a base station may be arranged to communicate with a core network and/or to provide services and/or control to one or more user equipments and/or to relay and/or transport communications and/or data between one or more user equipments and a core network and/or another base station and/or be Proximity Service enabled. An eNodeB (eNB) may be envisioned as an example of a base station, in particular according to LTE. A base station may generally be proximity service enabled and/or to provide corresponding services. It may be considered that a base station is configured as or connected or connectable to an Evolved Packet Core (EPC) and/or to provide and/or connect to corresponding functionality. The functionality and/or multiple different functions of a base station may be distributed over one or more different devices and/or physical locations and/or nodes. A base station may be considered to be a node of a wireless communication network. Generally, a base station may be considered to be configured to be a controlling node and/or to allocate resources in particular for device-to-device communication between two nodes of a wireless communication network, in particular two user equipments.

Device-to-device (D2D) communication or operation may generally refer to communication between nodes or D2D devices of or for a wireless communication network or corresponding operation of one or more nodes, which may utilize the frequency spectrum and/or frequency and/or time resources of the network, in particular according to LTE/E-UTRAN. The communication may be wireless communication. A device in this context may be a node of the wireless communication network, in particular a user equipment or a base station. Device-to-device communication may in particular be communication involving at least one user equipment, e.g. between two or more user equipments.

Device-to-device communication may be relayed and/or provided via a base station or coordinating node or relay node, in particular without interaction with a core network and/or layers of the network above a base station or coordinating node, or be direct communication between two devices, e.g. user equipments, without involvement of a base station or controlling node and/or with a base station or controlling node providing merely auxiliary services, e.g. configuration data or a transmission configuration or related information for a message intended for device-to-device communication between user equipments. D2D communication may be communication between two D2D devices in a region without cellular coverage and/or without interaction with a cellular or mobile network. In the latter case, it may be considered that data and/or signals flowing between the nodes performing device-to-device communication are not transported via a base station and/or controlling node. In contrast, during cellular communication, network layers above the eNB/base station/coordination node may generally be involved, in particular core layers which may be connected to the eNB/base station/coordinating node via cable/land line. During device-to-device communication, a message may be provided and/or transmitted and/or received. A message may be considered to be or be represented by a batch of physical layer transmissions and/or may comprise such. A command may be considered to be a message comprising an instruction.

A message may comprise information regarding the transmission configuration, in particular regarding related information, e.g. in a header, and/or a payload. A unidirectional message may be a message for connectionless communication and/or for which no prior communication and/or prior connection between the transmitting node and receiving node is necessary and/or available and/or for which no response or no response protocol or no handshake is expected. A device configured for and/or capable of device-to-device communication, which may be called D2D device or D2D enabled node, may comprise control circuitry and/or radio circuitry configured to provide device-to-device communication, in particular configured to enable proximity services (ProSe-enabled), e.g., according to LTE/E-UTRA requirements. D2D operation or communication and cellular operation or communication may be considered different operation types or modes, which may generally performed using resources from the same pool of available resources, e.g. allocated resources and/or the same carriers.

A storage medium may be adapted to store data and/or store instructions executable by control circuitry and/or a computing device, the instruction causing the control circuitry and/or computing device to carry out and/or control any one of the methods described herein when executed by the control circuitry and/or computing device. A storage medium may generally be computer-readable, e.g. an optical disc and/or magnetic memory and/or a volatile or non-volatile memory and/or flash memory and/or RAM and/or ROM and/or EPROM and/or EEPROM and/or buffer memory and/or cache memory and/or a database.

Resources or communication resources may generally be frequency and/or time resources. Allocated or scheduled resources may comprise and/or refer to frequency-related information, in particular regarding one or more carriers and/or bandwidth and/or subcarriers and/or time-related information, in particular regarding frames and/or slots and/or subframes, and/or regarding resource blocks and/or time/frequency hopping information. Allocated resources may in particular refer to UL resources, e.g. UL resources for a first D2D device to transmit to and/or for a second D2D device. Transmitting on allocated resources and/or utilizing allocated resources may comprise transmitting data on the resources allocated, e.g. on the frequency and/or subcarrier and/or carrier and/or timeslots or subframes indicated. It may generally be considered that allocated resources may be released and/or de-allocated. A network or a node of a network, e.g. an allocation node, may be adapted to determine and/or transmit corresponding allocation data indicating release or de-allocation of resources to one or more D2D devices, in particular to a first D2D device. Accordingly, D2D resource allocation may be performed by the network and/or by a node, in particular a node within and/or within a cell of a cellular network covering the D2D devices participating or intending to participate in the D2D communication.

Allocation data may be considered to be data indicating and/or granting resources allocated by the allocation node, in particular data identifying or indicating which resources are reserved or allocated for D2D communication for a D2D device and/or which resources a D2D device may use for D2D communication and/or data indicating a resource grant or release. A grant or resource grant may be considered to be one example of allocation data. It may be considered that an allocation node is adapted to transmit allocation data directly to a node and/or indirectly, e.g. via a relay node and/or another node or base station. Allocation data may comprise control data and/or be part of or form a message, in particular according to a pre-defined format, for example a DCI format, which may be defined in a standard, e.g. LTE. In particular, allocation data may comprise information and/or instructions to reserve resources or to release resources, which may already be allocated. Generally, allocation data may indicate and/or instruct transmission mode and/or configuration, in particular regarding a power level of transmission, e.g. for the first D2D device. The first D2D device may generally be adapted to perform transmission configuration according to allocation data, in particular to set a corresponding power level. It may be considered that allocation data comprises and/or is implemented as TPC and/or in TPC format.

A D2D transmission may be considered to be of a different type than a cellular and/or UL transmission. A transmission may pertain to a specific frequency and/or spectrum and/or bandwidth and/or carrier.

A receiver or receiver chain may generally be provided by a transceiver arrangement, which may have transmitting capabilities included, or as a separate arrangement, which may be implemented without having transmitting capacities included.

A measurement gap may refer to a time gap or interval, in which no transmission and reception happens, in particular regarding a serving cell or a given carrier. Since there is no signal transmission and reception during the gap (at least in the serving cell or given carrier), a D2D device or UE can switch to another or a target cell or carrier and/or perform a measurement on the target cell or carrier, e.g. for signal quality, utilizing the same receiver.

The term “intra-frequency” may refer to issued related to the same frequency/bandwith and/or carrier, e.g. between neighboring cells (which may be provided by different BSs) having the same frequencies available. The term “inter-frequency” may refer to issues related to different frequencies/bandwidths and/or carriers, e.g. between different carriers in a multi-carrier arrangement.

A receiving operation may comprise a measurement operation, e.g. a signal quality measurement, which may be performed in a measurement gap, in which a receiver switching to a carrier/frequency to be measured may be performed.

In the context of this description, a D2D device generally may be a device capable of D2D communication and/or operation, in particular using frequencies and/or resources of a cellular and/or licensed communication system, e.g. a system according to a LTE standard, and may be also referred to as D2D enabled or capable UE or node. A D2D device may comprise any entity or equipment or device or node capable of at least receiving and/or transmitting radio signals on a direct radio link, i.e., between the entity and another D2D capable entity or D2D device. A D2D device or D2D device may for example be comprised in or comprise a cellular UE, PDA, a wireless device, laptop, mobile, sensor, relay, D2D relay, a small base station employing a UE-like interface, etc. Any device or entity capable to support and/or perform at least one D2D operation may be considered a D2D device; a D2D device may be adapted to support and/or perform at least one D2D operation. A D2D device may generally be adapted for cellular operation and/or communication in a wireless communication network. It may be considered that a D2D device generally comprises radio circuitry and/or control circuitry for wireless communication, in particular D2D operation or communication and cellular operation or communication. A D2D device may comprise a software/program arrangement arranged to be executable by a hardware device, e.g. control circuitry, and/or storable in a memory of e.g. a UE or terminal, which may provide D2D functionality and/or corresponding control functionality to e.g. a UE or terminal.

D2D operation may comprise any action or activity related to D2D or D2D communication and may be used interchangeably with D2D communication. D2D operation may include, e.g., transmitting or receiving a signal/channel type or data for D2D purposes and/or in D2D operation, transmitting or receiving data by means of D2D communication, transmitting or receiving control or assistance data for D2D purpose, transmitting or receiving a request for control or assistance data for D2D, selecting a D2D operation mode, initiating/starting D2D operation, switching to D2D operation mode from a cellular operation mode, configuring receiver or transmitter with one or more parameters for D2D. D2D operation may be for a commercial purpose or to support public safety, using the data related to D2D.

D2D operation may or may not be specific to a certain D2D service. A D2D receive operation may be, and/or be comprised in, a D2D operation, which may, in one example, also involve other than D2D receive operations. A D2D operation may generally be performed or performable by a D2D device or UE. A D2D receive operation may comprise receiving, by a D2D device, of D2D data and/or signals. A D2D transmit operation may comprise, transmitting, by a D2D device, of D2D data and/or signals. A D2D device performing at least one D2D operation may be considered to be in D2D or D2D mode or in D2D operation. D2D operation may comprise D2D measurements.

A D2D measurement may be a measurement, e.g. performed by a D2D device, performed for D2D purpose and/or on D2D signals/channels and/or regarding D2D operation and/or communication. D2D measurement may comprise any one or any combination of: D2D RRM measurement, D2D positioning measurement, D2D synchronization measurement, measurement on D2D synchronization signals, measurement on D2D reference signals, measurement on D2D channel/s, signal-to-noise measurement, signal strength measurement, signal quality measurement, in particular measurement of received signal strength, of received signal quality, RLM, synchronization, one-directional and/or two-directional timing measurement, RTT or Rx-Tx or similar measurement, measurement of number of successful and/or unsuccessful channel decodings or receptions, data throughput measurements, measurement of amount of data transmitted and/or received, billing-relevant measurement; these measurement may be performed regarding D2D communication and/or D2D operation.

Cellular operation (in particular by a D2D device or UE) may comprise any action or activity related to a cellular network (any one or more RATs). Some examples of cellular operation may be a radio signal transmission, a radio signal reception, performing a radio measurement, performing a mobility operation or RRM related to a cellular network.

D2D transmission or communication may be any transmission or communication by a D2D device or device and/or in a D2D operation or mode or communication. Some examples of D2D transmission may comprise physical signals or physical channels, dedicated or common/shared, e.g., reference signal, synchronization signal, discovery channel, control channel, data channel, broadcast channel, paging channel, scheduling assignment (SA) transmissions, etc. A D2D transmission on a direct radio link may be intended for receiving by another D2D device. A D2D transmission may be a unicast, groupcast, or broadcast transmission. A D2D transmission may be on the uplink time-frequency resources of a wireless communication system.

A controlling node may generally be a network node connected or connectable to a D2D device for cellular and/or D2D communication. A controlling node may be defined by its functionality of providing and/or transmitting a measurement performance characteristic to a D2D device and/or of configuring the D2D device, in particular based on the measurement performance characteristic. A controlling node may be a network node that is adapted to schedule, decide and/or select and/or allocate, at least in part, time-frequency resources to be used for at least one of: cellular communication or transmissions and D2D communication or transmissions. The controlling node may also provide scheduling information and/or measurement performance characteristic to another node, such as another D2D device, a cluster head, a radio network node such as eNodeB, or a network node (e.g. a core network node), MME, positioning node, D2D server, RNC, SON, etc). The network node or controlling node may communicate with a radio network node. It may be envisioned that a controlling node may also perform coordination and/or control for one or more D2D device or UEs. The coordination and/or control may be performed in a centralized or distributed manner. A controlling node may be referred to as an allocating node and/or a coordinating node.

A network device or node and/or a D2D device may be or comprise a software/program arrangement arranged to be executable by a hardware device, e.g. control circuitry, and/or storable in a memory, which may provide D2D functionality and/or corresponding control functionality.

Radio spectrum: Although at least some of the examples may be described for D2D transmissions in the UL spectrum (FDD) or UL resources (TDD), the examples are not limited to the usage of UL radio resources, neither to licensed or unlicensed spectrum, or any specific spectrum at all.

A cellular network or mobile or wireless communication network may comprise e.g. an LTE network (FDD or TDD), UTRA network, CDMA network, WiMAX, GSM network, any network employing any one or more radio access technologies (RATs) for cellular operation. The description herein is given for LTE, but it is not limited to the LTE RAT.

RAT (radio access technology) may generally include: e.g. LTE FDD, LTE TDD, GSM, CDMA, WCDMA, WiFi, WLAN, WiMAX, etc.

A network node may be a radio network node (which may be adapted for wireless or radio communication, e.g. with a D2D device or a UE) or another network node. A network node generally may be a controlling node. Some examples of a radio network node or controlling node are a radio base station, in particular an eNodeB, a relay node, an access point, a cluster head, RNC, etc. The radio network node may be comprised in a mobile communication network and may support and/or be adapted for cellular operation or communication and/or D2D operation or communication. A network node, in particular a radio network node, may comprise radio circuitry and/or control circuitry, in particular for wireless communication. Some examples of a network node, which is not a radio network node, may comprise: a core network node, MME, a node controlling at least in part mobility of a wireless device, SON node, O&M node, positioning node, a server, an application server, a D2D server (which may be capable of some but not all D2D-related features), a node comprising a ProSe function, a ProSe server, an external node, or a node comprised in another network. Any network node may comprise control circuitry and/or a memory and/or may additionally or alternatively implemented in software and/or as a virtual network node, which may be running or intended to run on a hardware platform.

A network node may be considered to be serving a D2D device or UE, if it provides a cell of a cellular network to the served node or D2D device or UE and/or is connected or connectable to the D2D device or UE via and/or for transmission and/or reception and/or UL and/or DL data exchange or transmission and/or if the network node is adapted to provide the D2D device or UE with allocation and/or configuration data and/or a measurement performance characteristic and/or to configure the D2D device or UE.

Multiple carrier frequencies or functionality may refer to any of: different carrier frequencies within the same frequency band or within different frequency bands, same PLMN or different PLMNs, same RAT or different RATs. D2D operation may or may not occur on dedicated carrier frequencies. DL and UL carrier frequencies in FDD are also examples of different carrier frequencies. A frequency band herein may be FDD, TDD, HD-FDD, or unidirectional (e.g., DL-only band such as Band 29, in some examples). Multiple carrier functionality may include carrier aggregation functionality, in which multiple carriers or cells are used for transmission and/or reception between two participants of communication. The carriers may be continuous in the spectrum or discontinuous.

The term ‘TPC for D2D’ used herein may refer to or comprise at least one power control command for one or more of D2D transmissions (e.g., SA, D2D data, D2D synchronization signal, D2D control channel, D2D discovery transmission, any D2D transmission for D2D communication, any D2D transmission for D2D discovery). ‘TPC for cellular UL’ may comprise or refer to at least one power control command sent by or via a network node or eNodeB to control tx power of one or more cellular UL transmissions. The two different types of TPCs may be sent in the same or separate messages to the D2D device or UE, via the same or different channels or channel types (e.g., PDCCH and/or EPDCCH) and/or be comprises in one set or packet or message of allocation data or in different sets or packets or messages of allocation data.

A D2D device may generally be a node or device adapted to perform D2D communication, in particular transmission and/or reception, and/or at least one type of D2D operations. In particular, a D2D device may be a terminal and/or user equipment and/or D2D enabled machine and/or sensor. The D2D device may be adapted to transmit and/or receive D2D data based on allocation data, in particular on and/or utilizing resources indicate in the allocation data. D2D communication and/or transmission by a D2D device may generally be in UL resources and/or corresponding carrier or frequency and/or modulation. A D2D device (such as a UE) may be adapted for and/or capable of CA or CA operation. In particular, it may be adapted to transmit and/or receive one or more than one CCs and/or utilising, and/or participating in, carrier aggregation. A D2D device may be adapted to configure itself and/or be configured according to configuration data, which may include setting up and/or scheduling resources and/or equipment for receiving and/or transmitting and/or sharing of resources and/or in particular D2D operation and/or cellular operation based on the configuration data. Configuration data may be received, by the D2D device, from another node or D2D device, in particular a network node. A network node, in particular a controlling and/or allocating node, may generally be adapted to provide and/or determine and/or transmit configuration data, in particular to a D2D device. Configuration data may be considered to be a form of allocation data and/or may be provided in the form of a message and/or data packet/s.

Configuring a D2D device or UE, e.g. configuring by a network node, may include determining and/or transmitting configuration data to the device to be configured, i.e. the D2D device or UE. Determining the configuration data and transmitting this data to a D2D device or UE may be performed by different nodes, which may be arranged such that they may communicate and/or transport the configuration data between each other, in particular such that the node determining or adapted to determine the configuration data may transmit the configuration data to the node transmitting it or adapted to transmit it; the latter node may be adapted to receive the configuration data and/or relay and/or provide a message bases on the configuration data, e.g. by reformatting and/or amending and/or updating data received.

Transmit power (or power density) may generally refer to the power (or power density) of a signal transmitted or generally to the power of wireless transmission. Transmit power (or power density) may in particular refer to the power (or power density) of a signal transmitted by and/or transmissions of a D2D device or UE. Transmit power generally may refer to a specific channel and/or frequency and/or cell and/or carrier and/or bandwidth and/or carrier aggregate and/or a general setup. UL transmit power, or shorter UL power, may refer to the power of a signal transmitted, in particular by a D2D device or UE, in cellular operation and/or to or for a network node serving the D2D device or UE, for example a base station or eNodeB. D2D transmit power (or power density) may refer to the power (or power density) of a signal transmitted, in particular by a D2D device or UE, in D2D operation and/or for D2D transmission. Transmit power (or power density) may refer to or pertain to a time unit or interval, e.g. a slot, subframe or frame, and/or transmit power control may be performed for and/or updated in such units or intervals. Power control or transmit power control may generally refer to control of transmit power and/or transmit power spectral and/or temporal density. Power control commands in TPC format or TPC may be used for controlling power and/or to cause a D2D device or UE receiving at least one such command or TPC message to control power based on and/or according to the command or TPC. The command or TPC may be transmitted to the D2D device from or via a network node, in particular a base station or eNB or allocating node.

Capability data and/or a capability indication or indication message may provide and/or comprise capability information. In this context, the capability may refer to whether the D2D device or UE is capable of operating simultaneously perform D2D and cellular operations on a combination of carriers and/or frequency bands and/or to which combination/s of carriers and/or frequency bands a D2D device or UE can be configured, and/or is operable in and/or adapted to operate in, to simultaneously perform D2D and cellular operations; or at least a part of the corresponding combinations. Capabilities information and/or the indication or indication message, may indicate explicitly or implicitly one, or at least one, or a plurality of, combination/s of carriers and/or frequency bands on which the first D2D device or UE can be configured and/or is operable in and/or adapted to operate in, to simultaneously perform D2D and cellular operations, and/or may comprise parameters and/or parameter values and/or indication and/or information regarding the capabilities of the first D2D device. The capability indication or indication message may be transmitted or transmittable as a D2D transmission or a cellular transmission. It may be envisioned that a D2D device or UE determines and/or transmits and/or is adapted to determine and/or transmit such a message either and/or both as a D2D transmission and as a cellular transmission. In particular, a D2D device or UE may transmit or be adapted to transmit the indication or indication message as D2D transmission, in particular based on the target of the transmission being, and/or if the target of the transmission is, a second D2D device or UE, and/or based on corresponding D2D resources being, and/or if corresponding D2D resources are, allocated to the D2D device or UE. Alternatively or additionally, the D2D device or UE may transmit, and/or be adapted to transmit, the indication or indication message in or with a cellular transmission or operation, in particular if the target node is not a D2D device and/or based on cellular or only cellular resources being allocated to the D2D device or UE. A D2D device may be adapted to obtain capabilities information, e.g. by reading it from a memory or storage, which may be a memory or storage of the D2D device or UE.

A D2D device may comprise an obtaining module for obtaining capabilities information, e.g. as described herein. Additionally or alternatively, a D2D device may comprise a capabilities information transmitting device for transmitting a capabilities indication or indication message as described herein.

Cellular DL operation and/or communication of a D2D device or UE may refer to receiving transmissions in DL, in particular in cellular operation and/or from a network node/eNB/base station. Cellular UL operation of a D2D device or UE may refer to UL transmissions, in particular in cellular operation, e.g. transmitting to a network node/eNB/base station.

Indicating an information and/or condition, in particular indicating by a first node to a second node, may comprise transmitting the information, a corresponding message and/or data and/or indication, in particular from the first node to the second node node, e.g. via a cellular transmission or a D2D transmission, or if the first node and second node are connected by cable, via cable.

Each or any one of the D2D devices or user equipments shown in the figures may be adapted to perform the methods to be carried out by a user equipment or D2D device described herein. Alternatively or additionally, each or any of the D2D devices or user equipments shown in the figures may comprise any one or any combination of the features of a user equipment or D2D device described herein. Each or any one of the network nodes or controlling nodes or eNBs or base stations shown in the figures may be adapted to perform the methods to be carried out by network node or base station described herein. Alternatively or additionally, the each or any one of the controlling or network nodes or eNBs or base stations shown in the figures may comprise any one or any one combination of the features of a network node or eNB or base station described herein.

### SOME ABBREVIATIONS

3GPP 3^{rd} Generation Partnership Project

Ack/Nack Acknowledgment/Non-Acknowledgement, also A/N

ADC Analog-to-digital conversion

AGC Automatic gain control

ANR Automatic neighbor relations

AP Access point

BCH Broadcast channel

BER/BLER Bit Error Rate, BLock Error Rate;

BS Base Station

BSC Base station controller

BTS Base transceiver station

CA Carrier aggregation

CC Component carrier

CG Cell group

CGI Cell global identity

CP Cyclic prefix

CoMP Coordinated Multiple Point Transmission and Reception

CPICH Common pilot channel

CQI Channel Quality Information

CRS Cell-specific Reference Signal

CSG Closed subscriber group

CSI Channel State Information

CSI-RS CSI reference signal

D2D Device-to-device

D2D UE UE adapted for UE (in particular, a UE adapted for both cellular and D2D operation)

DAS Distributed antenna system

DC Dual connectivity

DFT Discrete Fourier Transform

DL Downlink; generally referring to transmission of data to a node/into a direction further away from network core (physically and/or logically); in particular from a base station or eNodeB to a D2D device or UE; often uses specified spectrum/bandwidth different from UL (e.g. LTE)

DL-SCH Downlink shared channel

DRX Discontinuous reception

EARFCN Evolved absolute radio frequency channel number

ECGI Evolved CG I

eNB evolved NodeB; a form of base station, also called eNodeB

EPDCCH Enhanced Physical DL Control CHannel

E-UTRA/N Evolved UMTS Terrestrial Radio Access/Network, an example of a RAT

f1, f2, f3, . . . , fn carriers/carrier frequencies; different numbers may indicate that the referenced carriers/frequencies are different

f1_UL, . . . , fn_UL Carrier for Uplink/in Uplink frequency or band

f1_DL, . . . , fn_DL Carrier for Downlink/in Downlink frequency or band

FDD Frequency division duplex

FFT Fast Fourier transform

HD-FDD Half duplex FDD

HO Handover

ID Identity

L1 Layer 1

L2 Layer 2

LTE Long Term Evolution, a telecommunications or wireless or mobile communication standard

M2M machine to machine

MAC Medium Access Control

MBSFN Multiple Broadcast Single Frequency Network

MCG Master cell group

MDT Minimisation of Drive Test

MeNB Master eNode B

MME Mobility management entity

MPC Measurement Performance Characteristic

MRTD Maximum receive timing difference

MSR Multi-standard radio

MTC Machine Type Communications

NW Network

OFDM Orthogonal Frequency Division Multiplexing

O&M Operational and Maintenance

OSS Operational Support Systems

PC Power Control

PCC Primary component carrier

PCI Physical cell identity

PCell Primary Cell

PCG Primary Cell Group

PCH Paging channel

PDCCH Physical DL Control CHannel

PDU Protocol data unit

PGW Packet gateway

PH Power Headroom

PHICH Physical HARQ indication channel

PHR Power Headroom Report

PLMN Public land mobile network

PSCell Primary SCell

PSC Primary serving cell

PSS Primary synchronization signal

PUSCH Physical Uplink Shared CHannel

RA Random Access

RACH Random Access CHannel

RAT Radio Access Technology

RB Resource Block

RE Resource Element

RF Radio frequency

RLM Radio link monitoring

RNC Radio Network Controller

RRC Radio resource control

RRH Remote radio head

RRM Radio Resource Management

RRU Remote radio unit

RSCP Received signal code power

RSRQ Reference signal received quality

RSRP Reference signal received power

RSSI Received signal strength indicator

RSTD Reference signal time difference

RX reception/receiver, reception-related

SCC Secondary component carrier

SA Scheduling Assignment

SCell Secondary Cell

SCG Secondary Cell Group

SeNB Secondary eNode B

SFN System frame number; or

SFN Single Frequency Network

SGW Signaling gateway

SI System Information

SINR/SNR Signal-to-Noise-and-Interference Ratio; Signal-to-Noise Ratio

SON Self Organizing Network

SSC Secondary serving cell

SSS Secondary Synchronization Signal

TA Timing advance

TAG Timing advance group

TDD Time Division Duplexing

TPC Transmit Power Control

TX,Tx,tx transmission/transmitter, transmission-related

UARFCN UMTS Absolute Radio Frequency Channel Number

UE User Equipment

UL Uplink; generally referring to transmission of data to a node/into a direction closer to a network core (physically and/or logically); in particular from a D2D device or UE to a base station or eNodeB; in the context of D2D, it may refer to the spectrum/bandwidth utilized for transmitting in D2D, which may be the same used for UL communication to a eNB in cellular communication; in some D2D variants, transmission by all devices involved in D2D communication may in some variants generally be in UL spectrum/bandwidth/carrier/frequency

These and other abbreviations may be used according to LTE standard definitions.

In this description, for purposes of explanation and not limitation, specific details are set forth (such as particular network functions, processes and signaling steps) in order to provide a thorough understanding of the technique presented herein. It will be apparent to one skilled in the art that the present concepts and aspects may be practiced in other examples and variants that depart from these specific details. For example, the concepts and variants are partially described in the context of Long Term Evolution (LTE) or LTE-Advanced (LTE-A) mobile or wireless communications technologies; however, this does not rule out the use of the present concepts and aspects in connection with additional or alternative mobile communication technologies such as the Global System for Mobile Communications (GSM). While the following examples will partially be described with respect to certain Technical Specifications (TSs) of the Third Generation Partnership Project (3GPP), it will be appreciated that the present concepts and aspects could also be realized in connection with different Performance Management (PM) specifications.

Moreover, those skilled in the art will appreciate that the services, functions and steps explained herein may be implemented using software functioning in conjunction with a programmed microprocessor, or using an Application Specific Integrated Circuit (ASIC), a Digital Signal Processor (DSP), a Field Programmable Gate Array (FPGA) or general purpose computer. It will also be appreciated that while the examples described herein are elucidated in the context of methods and devices, the concepts and aspects presented herein may also be embodied in a program product as well as in a system comprising control circuitry, e.g. a computer processor and a memory coupled to the processor, wherein the memory is encoded with one or more programs or program products that execute the services, functions and steps disclosed herein.

It is believed that the advantages of the aspects and variants presented herein will be fully understood from the foregoing description, and it will be apparent that various changes may be made in the form, constructions and arrangement of the exemplary aspects thereof without departing from the scope of the concepts and aspects described herein or without sacrificing all of its advantageous effects. Because the aspects presented herein can be varied in many ways, it will be recognized that any scope of protection should be defined by the scope of the claims that follow without being limited by the description.

1. Method for operating a network node in a wireless communication network, the method comprising configuring a D2D device for D2D operation based on a D2D schedule or resource allocation such that D2D operation, and/or switching between cellular operation and D2D operation and/or vice versa, of the D2D device doesn't overlap with cellular synchronization signals, and/or with DL subframes that can be used for cell search by the D2D device, and/or with DL subframes in which synchronization signals are transmitted.

2. Network node adapted for configuring a D2D device for D2D operation based on a D2D schedule or resource allocation such that D2D operation, and/or switching between cellular operation and D2D operation and/or vice versa, of the D2D device doesn't overlap with cellular synchronization signals, and/or with DL subframes that can be used for cell search by the D2D device, and/or with DL subframes in which synchronization signals are transmitted.

3. Method for operating a D2D device in a wireless communication network, the method comprising configuring a D2D operation to take place in subframes outside of a cell search sampling window, and/or to avoid overlap of D2D operation and/or switching between D2D operation and cellular operation and vice versa, with at least one time unit or resource for which the network or network node schedules synchronization signals to be transmitted.

4. D2D device, the D2D device being adapted for configuring a D2D operation to take place in subframes outside of a cell search sampling window, and/or to avoid overlap of D2D operation and/or switching between D2D operation and cellular operation and vice versa, with at least one time unit or resource for which the network or network node schedules synchronization signals to be transmitted.

5. Program product comprising a non-transitory medium storing code executable by control circuitry, the code causing the control circuitry to perform and/or control a method according to claim 1.

6. (canceled)
